(19) United States
(12) Patent Application Publication
(10) Pub. No.: US 2004/0047243 A1
(43) Pub. Date: Mar. 11, 2004

(54) Perpetual solar and seasonal calendar system

(76) Inventor: John Anthony Karageorge, Ocean City, MD (US)

Correspondence Address: JOHN A. KARAGEORGE, 14137 SEA CAPTAIN RD, OCEAN CITY, MD, 21842, US

(21) Appl. No.: 10/645,551

(22) Filed: Aug. 22, 2003

Related U.S. Application Data
(63) Continuation-in-part of application No. 09/986,566, filed on Nov. 9, 2001, now abandoned.

(51) Int. Cl. G04B 19/24

(52) U.S. Cl. 368/28

(57) ABSTRACT

An improved calendar system that calculates the 25th leap day with precision and determines which centuries are to receive the 25th leap day and which centuries do not. A calendar that has all four seasons starting at the beginning of a month instead of in the middle of a month. A calendar that has the New Year occur on the first day of spring when annual life forms begin anew. An intelligent time reckoning mechanism that meets the needs of any advanced civilization.

### CROSS-REFERENCE TO RELATED APPLICATIONS

This application is a Continuation-In-Part of Ser. No. 09/986,566 filed on Nov. 9, 2001.

### BACKGROUND OF THE INVENTION

1. Field of Invention

This invention is a perpetual calendar system that improves upon the Gregorian calendar in several ways with the foremost primary improvement being the accurate calculation of and the determination of which centuries should receive a 25th leap day. Another major feature of this invention is the alignment of the months with the four seasons.

2. Prior Art

Julius Caesar, on the advise of the Greek, Sosigenes, authorized the use of the Julian calendar in B.C. 46 (year 709 of Rome). This system remained in effect for the Western World until AD 1582 at which time several countries switched to the Gregorian calendar. St. Bede, the Venerable, an Anglo-Saxon monk, concluded in AD 730 that the Julian year was 11 minutes and 14 seconds longer than the solar year, but nothing was done to correct this discrepancy for another 800 years. To make up for the accumulated error in time, Pope Gregory XIII decreed that the day following Oct. 4, 1582, should be Oct. 15, 1582, thus starting the Gregorian calendar.

The Gregorian calendar was first adopted by France, Italy, Spain, Portugal, and Luxembourg. The British government, including the American colonies, switched to the Gregorian calendar in 1752. The day following Sep. 2, 1752, was decreed to be September 14, yielding a loss of 11 days. Under the new Gregorian calendar, New Year's Day was moved from March 25th (Julian calendar) to January 1st, which is a very peculiar place to have the new year start. Another shortcoming of the Gregorian calendar is that it only takes the solution to the 25th leap day so far; it does not bring the problem to conclusion.

Leap years are necessary because the solar year is 365 days 5 hours 48 minutes and 46 seconds long. That's 20,926 seconds more than 365 days. In one hundred years that accrues to 2,092,600 seconds (2,092,600/86,400 seconds per day=24.2199074 days—every century gets 24 leap days, the dilemma is determining which centuries get the 25th leap day). Five hours 48 minutes and 46 seconds is 11 minutes and 14 seconds short of ¼ day; if it were exactly 6 hours, the Julian calendar would have worked perfectly (add an extra day every four years without skipping a beat). At 25 leap days per century, the Julian calendar was accurate to within one day in 128 years.

The Gregorian calendar improved upon the Julian calendar by aligning a little more closer to the solar year, but not completely with the solar year. The Gregorian calendar currently calculates time at the rate of 24.25 leap days per century. It works this way: Leap years occur every four years starting on the first year of the century; however, century years that are not evenly divisible by 400 (1800, 1900, 2100, etc.) are not leap years for the Gregorian calendar, but they are for the Julian calendar. This means that the Gregorian calendar allows for the 25th leap day to be added to every fourth century. As already stated, the Gregorian calendar has 24.25 leap days per century ((3×24+25)/4=24.25 leap days per century), which makes it accurate to within one day in 3,323 years.

If we use the advice presented by Britannica encyclopedia (don't add the 25th leap day to centuries that are evenly divisible by 4000 (10 cycles of 400 years)), the Gregorian calendar leap day ratio would change from 24.25 to 24.225 days per century in two thousand years. ((30×24)+(10×25)−1)/40=24.225 leap days per century. At 24.225 leap days per century, the Gregorian calendar is accurate to within one day in 20,000 years (it's precisely 19,636.363 years). This will become more apparent as you view the following manual algorithmic scenario (algorithm # 1) which is generated as a result of the Britannica prescription. This algorithm clearly shows some of the flaws of the Gregorian calendar.

Algorithm #1 Gregorian Calendar
Solar year = 365 days 5 hours 48 minutes & 46 seconds

| | | |
|---|---|---|
| 5 hrs. 48 min. 46 sec. = | 20,926 | seconds |
| | × 100 | years |
| surplus seconds: | 2,092,600 | |
| 2,092,600/86,400 = | 24.2199074074 | days per century |
| .2199074074 days = | 19,000 | seconds of surplus |
| 19,000 × 4 centuries = | 76,000 | surplus seconds |
| (add 25th day) | − 86,400 | (400 years) |
| | −10,400 | deficit |
| | × 10 | time periods |
| | −104,000 | deficit |
| (don't add 25th day) | + 86,400 | (4,000 years) |
| | −17,600 | deficit |
| | × 5 | time periods |
| | −88,000 | deficit |
| (skip 12/31) | + 86.400 | (20,000 years) |
| | −1,600 | deficit |
| | × 54 | time periods |
| | −86,400 | deficit |
| (skip 12/30) | + 86,400 | (1,080,000 years) |
| | 0 | (−55 days) |

Gregorian calendar aligned with the solar year.

As you can see, 0.25 is greater than 0.2199074; therefore, the Gregorian calendar is over compensating causing a deficit of time when it adds the 25th leap day to the fourth century. The original surplus of 19,000 seconds (0.2199074 days) every 100 years grows to 76,000 seconds in 400 years. When we add a 25th leap day for that century we over compensate by 10,400 seconds causing a deficit of time. That deficit grows to 104,000 seconds after 4000 years at which time we do not add the 25th leap day. This compensation still leaves us with a deficit of 17,600 seconds which grows to 88,000 seconds in 5 time periods (20,000 years). So every 20,000 years we not only do not add the 25th leap day, we must also subtract one day from our calendar. This process continues exactly this way for 1,080,000 years at which time we subtract 2 days and then the cycle starts over again. The fallacy with this system, as prescribed by Britannica Encyclopedia, is, if we continue using the algorithmic scenario “400 years, 4,000 years, 20,000 years . . . . ” we would eventually need to delete 55 common days from our calendar in order to align with the solar year.

In brief, the Gregorian calendar is deficient in three major areas:

(1) It does not calculate the 25th leap day efficiently enough for an advanced civilization;

(2) With New Year's Day occurring on January 1 (12 days into winter), we have two winters every year; and

(3) All of our seasons fall in the middle of a month instead of at the beginning of a month.

The primary difference distinguishing this invention from other perpetual calendar inventions such as U.S. Pat. No. 6,116,656 issued Sep. 12, 2000, to Terrance A. Glassman and U.S. Pat. No. 4,813,707 issued Mar. 21, 1989, to Mohammed K. Habib and to all other calendaring inventions is the other calendaring inventions are geared towards and therefore coincide with one or more of the calendar systems in use today. They are designed to function with what the major calendar systems yield (or allow). Therefore, they are merely creative extensions of existing systems. The instant invention differs in that it sets a new precedence; namely, all four seasons fall on the first of a month, the New Year starts on the first day of spring, and it determines which centuries receive the 25th leap year. The instant invention not only identifies the problem of the 25th leap year, it also solves the age old problem of aligning the calendar with the solar year by determining which centuries get the 25th leap year and which centuries don't get the 25th leap year over a period of 86,400 years at which time the instant invention is aligned with the solar year making it a truly perpetual calendar. The algorithm that calculates which centuries get the 25th leap year, hereafter known as the JAK-Perpetual-Solar-Calendar algorithm, can be incorporated into any computer or electronic device and programmed to run, thus alleviating any human intervention.

3. Objects and Advantages

One of the advantages the present invention has over the Gregorian Calendar System is it utilizes an efficient time calculating multi-tiered cyclic algorithm that incorporates a 400-year cycle within a 3200-year cycle within an 86,400-year cycle in the process of determining which iteration of the 400-year cycles is to receive the 25th leap year. Simply put, the instant invention is on an 86,400 year major cycle that is much more efficient and accurate than the 1,080,000 year major cycle that the current state of the art (Britannica encyclopedia) surmises. The JAK-Perpetual-Solar-Calendar manual algorithm allows for the alignment of the present invention with the solar year after 86,400 years, which is numerically displayed in the table illustrated in FIG. 2.

Clearly, an 86,400-year cycle is more desirable that a 1,080,000-year cycle, not even taking into consideration the fact that 55 common days will have to be deleted from 54 different years using the suggestion by Britannica, which is still more efficient than the current mechanics of the Gregorian calendar.

The present invention accomplishes the following objectives:

(1) It efficiently calculates the 25th leap day and signifies which centuries are to receive it, a feat that no previous calendar system has been able to accomplish until now;

(2) It aligns with the four seasons and brings some semblance of intelligence to our reckoning of time;

(3) It starts the New Year at the beginning of spring, where it belongs;

(4) It is simply a smart system that any advanced civilization would require and use.

The JAK-Perpetual-Solar-Calendar manual algorithm can be incorporated into any electronic device, computer, etc., as an automatic algorithm for the purpose of determining and printing a list of future dates to be used in the business world, the political world, or for any other reason.

A better understanding of the advantages of the present invention will become apparent as you view the JAK-Perpetual-Solar-Calendar manual algorithm (algorithm #2), the table of information that is derived from it, and the description of their efficient productions.

### SUMMARY

The Julian calendar tried to align with the solar year by having 25 leap days per century, one leap year every 4 years. The Gregorian calendar attained a closer alignment with the solar year by having 24.25 leap days per century. A suggestion by Britannica brings it even closer to perfection yielding 24.225 leap days per century. The present invention brings the problem of the 25th leap day to closure by incorporating an all encompassing algorithm that precisely calculates the exact centuries to which the 25th leap day should be added making it a true perpetual calendar. The present invention also aligns with the four seasons and puts New Year's day in its proper place.

### BRIEF DESCRIPTION OF THE FIGURES

FIG. 1 provides a table illustrating the layout of the year for this invention;

FIG. 2 provides a table depicting the results of the JAK-Perpetual-Solar-Calendar algorithm.

### DETAILED DESCRIPTION OF THE INVENTION

A physical copy of the Perpetual Solar and Seasonal Calendar can take the form of various multiple constructed arrangements, whether they be printed or otherwise.

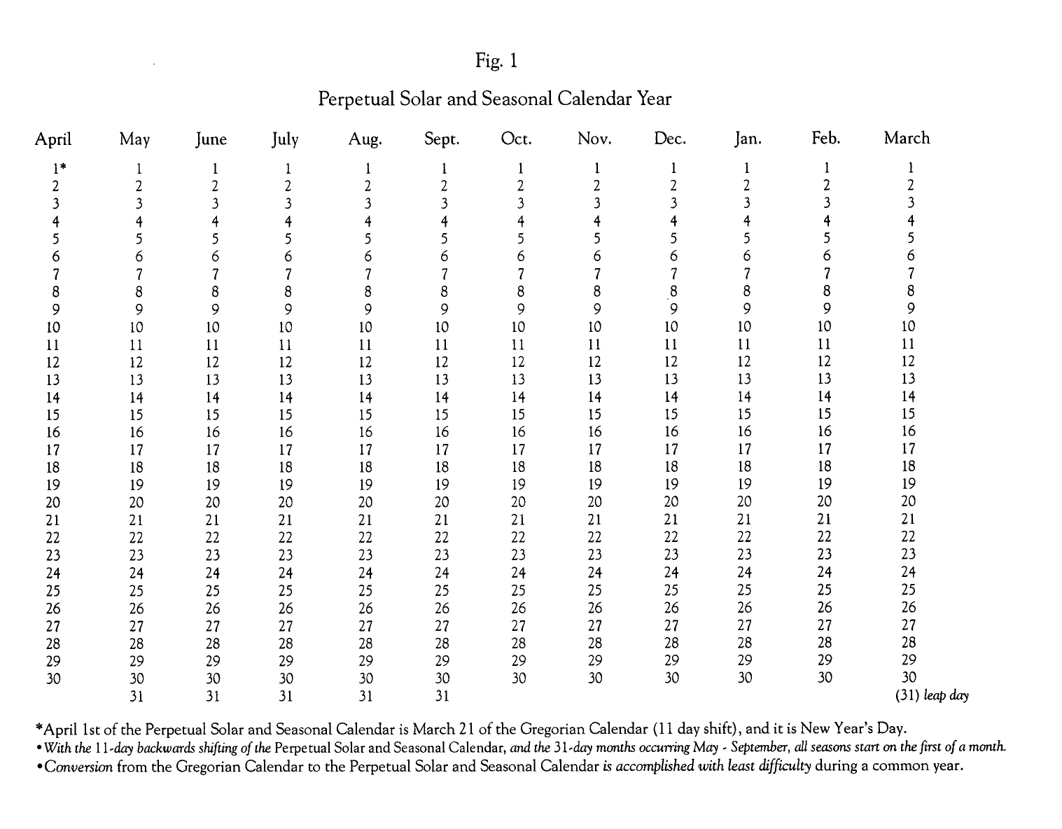

FIG. 1 is a table that clearly shows April 1st is the beginning of the year for the present invention. It also shows that the months May through September are all 31-day months and all other months have 30 days with the exception of March, which gets the periodic leap day.

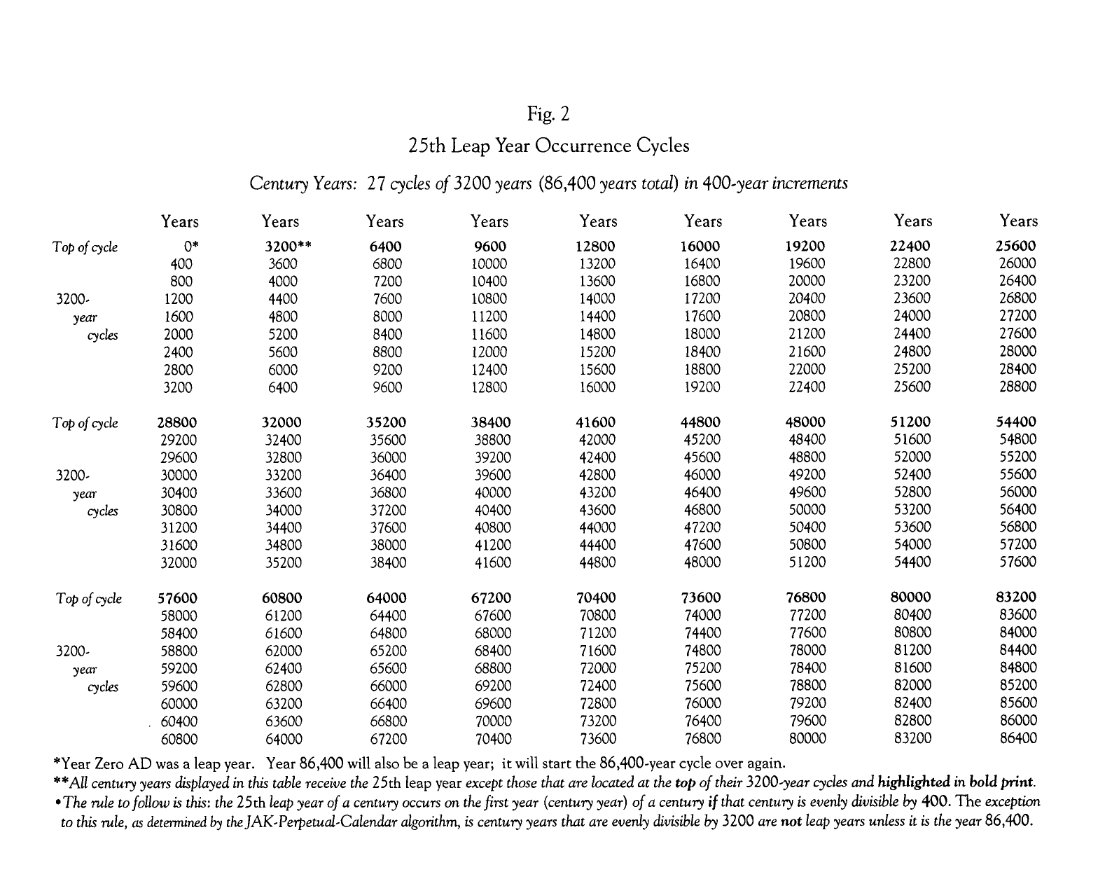

FIG. 2 is a table that shows the 400-year cycles within the 3200-year cycles within the 86,400-year cycle of the Perpetual Solar and Seasonal Calendar/solar-year alignment process. It is derived from the JAK-Perpetual-Solar-Calendar manual algorithm and it clearly illustrates that the century years occurring at the top of the twenty-seven 3200-year cycles (years 0, 3200, 6400, . . . ) are those years that do not get the 25th leap day. The only exception to that rule is the first year of the table, year 0, which will become year 86,400 when the cycle repeats itself; it always gets the 25th leap day. All other century years listed in the table always get the 25th leap day.

Algorithm #2 JAK-Perpetual-Solar-Calendar Algorithm
Solar year = 365 days 5 hours 48 minutes & 46 seconds

| | | |
|---|---|---|
| 5 hrs. 48 min. 46 sec. = | 20,926 | seconds |
| | × 100 | years |
| surplus seconds: | 2,092,600 | |
| 2,092,600/86,400 = | 24.2199074074 | days per century |
| .2199074074 days = | 19,000 | seconds of surplus |
| 19,000 × 4 centuries = | 76,000 | surplus seconds |
| (add 25th day) | − 86.400 | (400 years) |
| | −10,400 | deficit |
| | × 8 | time periods |
| | −83,200 | deficit |
| (don't add 25th day) | + 86,400 | (3,200 years) |
| | 3,200 | surplus |
| | × 27 | time periods |
| | 86,400 | surplus |
| (add 25th day) | − 86,400 | (86,400 years) |
| | 0 | |

Perpetual Solar and Seasonal Calendar aligned with the solar year.

Operation—Preferred Embodiment

The JAK-Perpetual-Solar-Calendar algorithmic scenario “400 years, 3,200 years, 86,400 years” yields a much shorter life cycle than the current state of the art and corrects the problem of deleting common days. If we take the 10,400 second deficit that occurs at the 400-year interval with the Gregorian calendar scenario and let it grow for 8 time periods (3,200 years) instead of 10 time periods, the deficit grows to 83,200 seconds. If, at that time, we don't add the 25th leap day, this transaction leaves us with a 3,200 second surplus. This scenario continues for 27 time periods (86,400 years) at which time we add the 25th leap day and the calendar is aligned with the solar year. The preceding Algorithm #2 scenario of this specification more clearly portrays these events.

State of the Art technology and wisdom suggests that the solar year is exactly 365 days 5 hours 48 minutes and 45.9747 seconds long (How they compute this with so much precision, I do not know). That's 0.0253 seconds short of the 46 seconds I used as the standard in the JAK-Perpetual-Solar-Calendar algorithm, which yields the result of the 86,400-year cycle. This difference produces the following:

The present invention is accurate to within one day every 3,415,019.762846 years; or accurate to within one second every 39.5256916996 years, or 2,185.92 seconds (36 minutes and 25.92 seconds) every 86,400 years. So for every major cycle this system completes, it will be off 2,185.92 seconds or just over ½ hour. To compensate for this, a 25th day would not be added at the end of the 20th major cycle of 86,400 years (1,728,000 years), thereby keeping this system to within ½ day of accuracy as opposed to being off by one complete day in 3,415,019 years.

The other improvements that the present invention makes are as follows:

(a) The shifting of the entire calendar by eleven days (from April 1 to March 21), thereby causing the seasons of spring and winter to start on the beginning of April and January, respectively;

(b) The reassignment of May, June, July, August, and September each having 31 days and all other months having 30 days, thereby causing the other two seasons to begin on the first of July (summer), and the first of October (fall);

(c) The moving of New Year's Day to April 1, the first day of spring; and

(d) The reassignment of leap day to occur on March 31, the last day of the year.

In practice, the JAK-Perpetual-Solar-Calendar manual algorithm of my calendar system can be incorporated into electronic devices as software (automatic algorithm) or hard-wired into them as ROM and we shall never have to worry about which future centuries will have the 25th leap day. All in all the Perpetual Solar and Seasonal Calendar is a much smarter calendar, one that our society is ready for.

I claim:

1. An electronic memory having stored therein an algorithm for calculating which centuries will receive a 25th leap year within a repeating life cycle of 86,400 years comprising the steps of:
(a) applying said 25th leap year to year zero, the first year of the first iteration of the 86,400-year-life-cycle,
(b) applying said 25th leap year to those century years that are evenly divisible by 400, but not applying said 25th leap year to those century years that are evenly divisible by 3200,
(c) applying said 25th leap year to year 86,400, the first year of the second iteration of said 86,400-year-life-cycle which starts said 86,400-year-life-cycle over again.

2. A method of determining which centuries will receive a 25th leap year within a repeating life cycle of 86,400 years comprising the steps of:
(a) providing a means for applying said 25th leap year to year zero, the first year of the first iteration of the 86,400-year-life-cycle,
(b) providing a means for applying said 25th leap year to those century years that are evenly divisible by 400, but not applying said 25th leap year to those century years that are evenly divisible by 3200,
(c) providing a means for applying said 25th leap year to year 86,400, the first year of the second iteration of said 86,400-year-life-cycle which starts said 86,400-year-life-cycle over again.

3. A perpetual calendar system encompassing a total of 365 days in a common year and 366 days in a leap year where both the common year and the leap year are composed of 12 months and each month is composed of a seven-day recurring week that continuously repeats from week to week, month to month, year to year, century to century, etcetera, wherein the improvement comprising a means for determining which centuries will receive a 25th leap year.

4. The perpetual calendar system of claim 3 further including April 1 as the first day of the calendar year.

5. The perpetual calendar system of claim 3 further including April 1 as the first day of spring or the first full day of spring, currently March 21 of the Gregorian calendar.

6. The perpetual calendar system of claim 3 further including the months of April, October, November, December, January, and February having 30 days each.

7. The perpetual calendar system of claim 3 further including the months of May, June, July, August, and September having 31 days each.

8. The perpetual calendar system of claim 3 further including the month of March having 30 days in a common year and 31 days in a leap year.

9. The perpetual calendar system of claim 3 further including the designation of the century year as the first year of the century, and the designating of the last year of said century, the 100th year, to have 99 as its last two digits, 1999, 2099, etcetera.

10. The perpetual calendar system of claim 3 further including every century receives 24 leap years starting on the fifth year of said century, year 04, and incremented every four years ending on the ninety-seventh year of said century, year 96.

11. The perpetual calendar system of claim 3 wherein said perpetual calendar aligns with the solar year after a period of 86,400 years when said 25th leap year is applied to year 0, the first year of the 86,400-year-life-cycle, and said 25th leap year is applied to those century years that are evenly divisible by 400, but not applied to those century years that are evenly divisible by 3200, and finally, when said 25th leap year is applied to year 86,400, the year that starts the 86,400-year cycle anew.
